(19) United States
(12) Patent Application Publication
(10) Pub. No.: US 2008/0059095 A1
(43) Pub. Date: Mar. 6, 2008

(54) Electronic Device Handling Apparatus and Defective Terminal Determination Method

(75) Inventor: Masayoshi Ichikawa, Tokyo (JP)

Correspondence Address: POSZ LAW GROUP, PLC, 12040 SOUTH LAKES DRIVE, SUITE 101, RESTON, VA, 20191, US

(73) Assignee: ADVANTEST CORPORATION, Tokyo (JP)

(21) Appl. No.: 11/791,272

(22) PCT Filed: Nov. 25, 2005
(86) PCT No.: PCT/JP05/21722

§ 371 Date: Aug. 28, 2007

(30) Foreign Application Priority Data
Nov. 30, 2004 (JP) PCT/JP2004/017749

(51) Int. Cl. G06F 19/00

(52) U.S. Cl. 702/82; 702/81; 702/84

(57) ABSTRACT

Standard positional information of respective terminals of an electronic device to be a standard is stored in advance, an image of terminals of an electronic device to be tested held by a conveyor apparatus is taken by an image pickup apparatus, obtaining positional information of respective terminals from image data of the terminals of the electronic device to be tested taken the image thereof and, by comparing the standard positional information of respective terminals of the electronic device as a standard with the obtained positional information of the terminals of the electronic device to be tested, a missing and/or an arrangement position defect of a terminal of the electronic device to be tested is determined.

### TECHNICAL FIELD

The present invention relates to an electronic device handling apparatus and a method of determining a defective terminal, by which a missing or deviation of an arrangement position, etc. of a solder ball and a lead pin of an IC device can be detected.

### BACKGROUND ART

In a production procedure of an electronic device, such as an IC device, an electronic device testing apparatus is used for testing performance and functions of the finally produced electronic device.

An electronic device testing apparatus as an example of the related art is provided with a test section for conducting a test on electronic devices, a loader section for sending pre-test IC devices to the test section and an unloader section for taking out post-test IC devices from the test section and classifying them. The loader section is provided with a buffer stage capable of moving back and forth between the loader section and the test section, and a loader section conveyor apparatus, wherein a suction portion for picking up and holding IC devices is provided, capable of moving in a range from a customer tray to a heat plate and from the heat plate to the buffer stage. Also, the test section is provided with a contact arm capable of picking up and holding IC devices and pressing against sockets of a test head and a test section conveyor apparatus capable of moving in a range of the test section.

In the loader section conveyor apparatus, IC devices carried on the customer tray are picked up and held by the suction portion and loaded on the heat plate and, then, the IC devices heated to be a prescribed temperature on the heat plate are again picked up and held by the suction portion and loaded on the buffer stage. Then, the buffer stage loaded with the IC devices moves from the loader section to the test section side. Next, the test section conveyor apparatus uses the contact arm to pick up and hold the IC devices on the buffer stage and press them against sockets of the test head, so that external terminals (device terminals) of the IC devices are brought to contact with contact terminals (socket terminals) of the sockets.

In that state, by applying to the IC devices test signals supplied to the test head from the tester body through a cable and sending response signals read from the IC devices to the tester body through the test head and cable, electric characteristics of the IC devices are measured.

Here, when the contact arm of the test section conveyor apparatus presses the IC devices against the sockets as explained above, if holding positions of the IC devices on the contact arm are deviated, contact between device terminals and socket terminals is not made surely and the test cannot be conducted accurately. Accordingly, positions of IC devices on the contact arm have to be regulated accurately.

Particularly, in recent years, IC devices to be used in mobile communication devices, such as a mobile phone, have pursued to have a smaller area and thin body, while the number of device terminals has rapidly increased as the integrated circuit becomes furthermore highly integrated and to have more functions. For example, when device terminals are solder balls, intervals of their arrangement is as narrow as 0.4 mm. When the pitches of the device terminals become narrower and finer, it becomes hard to make the device terminals and the socket terminals contact accurately.

To solve the problem, an electronic device testing apparatus for measuring a position of an IC device by using an image processing technique and aligning it with sockets of the test head has been developed (for example, International Publication Gazette No. 03/075025). In such an electronic device testing apparatus, an image of the IC device to be tested in the middle of being conveyed by a conveyor is taken by an optical image pickup apparatus, such as a CCD (charge-coupled device) camera, and calculating an amount of positional deviation of the IC device based on the taken image. The conveyor apparatus corrects a position of the IC device to be tested based on the calculated positional deviation and conveys the IC device to the sockets. Calculation of a positional deviation amount of the IC device is performed by detecting device terminals in the image by using an image processing technique and measuring the center coordinates of an overall arrangement of the device terminals and a rotation angle.

### DISCLOSURE OF THE INVENTION

### Problem to be Solved by the Invention

To conduct an accurate test on an IC device, it is necessary that all of device terminals of the IC device contact with socket terminals. However, in the case of a device using solder balls as device terminals, such as a BGA (ball grid array) package, a part of the solder balls may be absent due to a trouble in a step of mounting solder balls, etc. In the case of such a device, a signal is not input to or output from the absent terminal and a test cannot be conducted accurately. In this case, the test itself becomes useless.

Also, a part of solder balls is deviated from its mounting position due to a trouble in a step of mounting the solder balls in some cases. In that case, contact between the device terminals and socket terminals becomes insufficient and electric resistance increases at the contact portion, which results in a problem that an accurate test cannot be conducted.

Furthermore, a solder ball mounted at a deviated position may fall out of the package due to a force in the crosswise direction generated by contact with a socket terminal. In that case, the problem is that not only the device becomes defective, but the fallen solder ball remains on the socket to hinder a test on IC devices to be conveyed thereafter. Furthermore, when a solder ball falls out after conducting the test as such, there is the risk of producing a defective device by the testing step and shipping it as it is.

Conventionally, visual exterior inspection was made on devices before and after the testing step to overcome the problems. However, visual exterior inspection requires a long time, so that the productivity largely declines and the production cost of IC devices is increased.

The present invention was made in consideration of the above circumstances and has as an object thereof to provide an electronic device handling apparatus and a defective terminal determination method, by which a defect of a terminal of an electronic device can be detected.

### Means for Solving the Problem

To attain the above object, firstly, according to the present invention, there is provided an electronic device handling device for conveying an electronic device to a contact portion and bringing it contact with the contact portion to test electrical properties of the electronic device, comprising: a storage device for storing standard positional information of respective terminals of an electronic device as a standard; an image pickup apparatus for taking an image of terminals of an electronic device to be tested; a terminal position information obtaining means for obtaining positional information of respective terminals from image data of the terminals of an electronic device to be tested taken by the image pickup apparatus; and a defective terminal determination means for determining a missing and/or an arrangement position defect of a terminal of an electronic device to be tested by reading standard positional information of respective terminals of the electronic device as a standard from the storage device and comparing the read out standard positional information of respective terminals with positional information of respective terminals of the electronic device to be tested obtained by the terminal position information obtaining means (the invention 1).

According to the above invention (the invention 1), a visual exterior inspection become unnecessary and a missing and/or an arrangement position defect of a terminal of an electronic device to be tested can be automatically detected.

In the above invention (the invention 1), the electronic device handling apparatus furthermore comprises a conveyor apparatus capable of holding an electronic device to be tested and pressing it against the contact portion; and the image pickup apparatus takes an image of terminals of a pre-test electronic device held by the conveyor apparatus (the invention 2).

According to the above invention (The invention 2), a terminal defect of an electronic device to be tested can be detected before conducting a test, so that a useless test on an electronic device having a defective terminal does not have to be conducted. Also, by omitting an electronic device, wherein an arrangement position of a terminal is defective, from the test in advance, it is possible to reduce the possibility that a terminal falls off due to the test and remains on the contact portion.

In the above invention (the invention 2), the electronic device handling apparatus furthermore comprises a position correction amount calculation means for obtaining a correction amount of a position of an electronic device to be tested by comparing standard positional information of respective terminals of the electronic device as a standard read from the storage device with positional information of respective terminals of the electronic device to be tested obtained by the terminal position information obtaining means; and the conveyor apparatus comprises a position correction device for correcting a position of an electronic device to be tested held by the conveyor apparatus based on the correction amount obtained by the position correction amount calculation means (the invention 3).

According to the above invention (the invention 3), correction of a position (alignment with the contact portion) of an electronic device to be tested can be conducted, while a terminal defect of an electronic device to be tested is detected. Accordingly, the electronic device to be tested can be surely brought to contact with the contact portion and a terminal detection can be detected without deteriorating the throughput.

In the above inventions (the inventions 1 to 3), preferably, an electronic device to be tested determined by the defective terminal determination means that a terminal is missing or an arrangement position of a terminal is defective is omitted from an electric test and/or classified as a defective electronic device (the invention 4).

In the above inventions (the inventions 2 and 3), the conveyor apparatus is capable of holding a plurality of electronic devices to be tested and presses against the contact portion an electronic devices to be tested determined by the defective terminal determination means that there is no missing terminal or there is no defect on an arrangement position of a terminal, but does not press against the contact portion an electronic device to be tested determined that a terminal thereof is missing or an arrangement position of a terminal is defective (the invention 5).

According to the above invention (the invention 5), even if a terminal of a part of the electronic devices to be tested has a defect among a plurality of electronic devices to be tested held by the conveyor apparatus, a test can be conducted on electronic devices with good terminals, so that the test can be efficiently conducted.

In the above invention (the invention 1), the image pickup apparatus takes an image of terminals of a pre-test electronic device and terminals of a post-test electronic device (the invention 6). According to the invention (the invention 6), a missing of a terminal or deviation of a mounting position of an electronic device due to the test can be detected, by comparing terminals of the pre-test electronic device with terminals of the post-test electronic device. Therefore, it is possible to prevent shipping of an electronic device made to have a terminal defect by a test even though the test is conducted normally. Also, when missing of a terminal is detected after the test, there is a possibility that the terminal remains on the contact portion, but it is possible to prevent the situation that next electronic devices to be tested are pressed against the contact portion, on which the terminal remains, by setting off an alarm and stopping conveying.

In the above invention (the invention 6), a second defective terminal determination means for determining a missing and/or an arrangement position defect of a terminal of the post-test electronic device by comparing positional information of respective terminals obtained from image data of terminals of the post-test electronic device taken by the image pickup apparatus with standard positional information of respective terminals of the electronic device as a standard read from the storage device may be furthermore included (the invention 7), or a second defective terminal determination means for determining a missing and/or an arrangement position defect of a terminal of the post-test electronic device by comparing positional information of respective terminals obtained from image data of terminals of the post-test electronic device taken by the image pickup apparatus with positional information of respective terminals of the pre-test electronic device obtained by the terminal position information obtaining means may be included (the invention 8).

In the above inventions (the inventions 7 and 8), preferably, an electronic device to be tested determined by the second defective terminal determining means that a terminal is missing or an arrangement position of a terminal is defective is classified as a defective electronic device (the invention 9).

Also, in the above inventions (the inventions 7 to 9), preferably, n alarm sets off when the second detective terminal determining means determines that a terminal is missing or an arrangement position of a terminal is defective (the invention 10).

Furthermore, in the above inventions (the inventions 7 to 10), the electronic device handling apparatus furthermore comprises a display device; and when the second detective terminal determining means determines that a terminal is missing or an arrangement position of a terminal is defective, the display device displays information on the defective terminal (the invention 11).

Secondary, according to the present invention, there is provided a defective terminal determination method for determining a missing and/or an arrangement position defect of a terminal of an electronic device to be tested in an electronic device handling apparatus, comprising the steps of: storing standard positional information of respective terminals of an electronic device as a standard; obtaining positional information of respective terminals from image data obtained by taking an image of the terminals of an electronic device to be tested; and determining a missing and/or an arrangement position defect of a terminal of the electronic device to be tested by reading standard positional information of respective terminals of the electronic device as a standard, and comparing the read out standard positional information of respective terminals with the obtained positional information of respective terminals of the electronic device to be tested (the invention 12).

According to the above invention (the invention 12), a visual exterior inspection become unnecessary and a missing and/or an arrangement position defect of a terminal of an electronic device to be tested can be automatically detected.

In the above invention (The invention 12), a step of obtaining a correction amount of position of an electronic device to be tested by comparing the standard positional information of respective terminals of the electronic device as a standard with the obtained positional information of respective terminals of the electronic device to be tested and correcting the position of the electronic device to be tested based on the correction amount may be furthermore included (the invention 13).

In the above inventions (the inventions 12 and 13), a step of omitting an electronic device to be tested determined that a terminal is missing or an arrangement position of a terminal is defective and/or classifying it as a defective electronic device may be furthermore included (the invention 14).

In the above inventions (the inventions 12 to 14), a step of taking an image of terminals of a post-test electronic device; and the step of determining a missing of a terminal and/or an arrangement position defect of a terminal of the post-test electronic device by comparing positional information of respective terminals obtained from image data of terminals of the post-test electronic device taken an image thereof with the standard positional information of respective terminals of the electronic device as a standard may be furthermore included (the invention 15). Alternately, steps of taking an image of terminals of a pre-test electronic device; taking an image of terminals of a post-test electronic device; and determining a missing of a terminal and/or an arrangement position defect of a terminal of the post-test electronic device by comparing positional information of respective terminals obtained from image data of terminals of the pre-test electronic device taken an image thereof with positional information of respective terminals obtained from image data of terminals of the post-test electronic device taken an image thereof may be furthermore included (the invention 16).

In the above inventions (the inventions 15 and 16), a step of classifying an electronic device to be tested determined that a terminal is missing or an arrangement position of a terminal is defective as a defective electronic device may be furthermore included (the invention 17).

In the above inventions (the inventions 15 to 17), a step of setting off an alarm when determined that a terminal is missing or an arrangement position of a terminal is defective may be furthermore included (the invention 18).

In the above inventions (the inventions 15 to 18), a step of displaying information on a defective terminal on a display device when determined that a terminal is missing or an arrangement position of a terminal is defective may be furthermore included (the invention 19).

According to the electronic device handling apparatus and the defect terminal determination method of the present invention, a missing of a terminal or deviation of a mounting position of an electronic device can be detected.

### BRIEF DESCRIPTION OF DRAWINGS

FIG. 1 is a plan view of a handler according to an embodiment of the present invention.

FIG. 2 is a partially sectional view from the side of the handler according to the same embodiment (a sectional view along I-I in FIG. 1).

FIG. 3 is a view from the side of a contact arm and an image pickup apparatus used in the handler.

FIG. 4 is a view from the side of the contact arm and a contact portion used in the handler.

FIG. 5A is a flowchart showing an operation of the handler.

FIG. 5B is a flowchart showing an operation of the handler.

FIG. 6 is a conceptual view of an image processing step (when there is no defective point in solder balls of an IC device) in the handler.

FIG. 7 is a conceptual view of an image processing step (when there is a defective point in solder balls of an IC device) in the handler.

### BEST MODE FOR CARRYING OUT THE INVENTION

Below, an embodiment of the present invention will be explained based on the drawings.

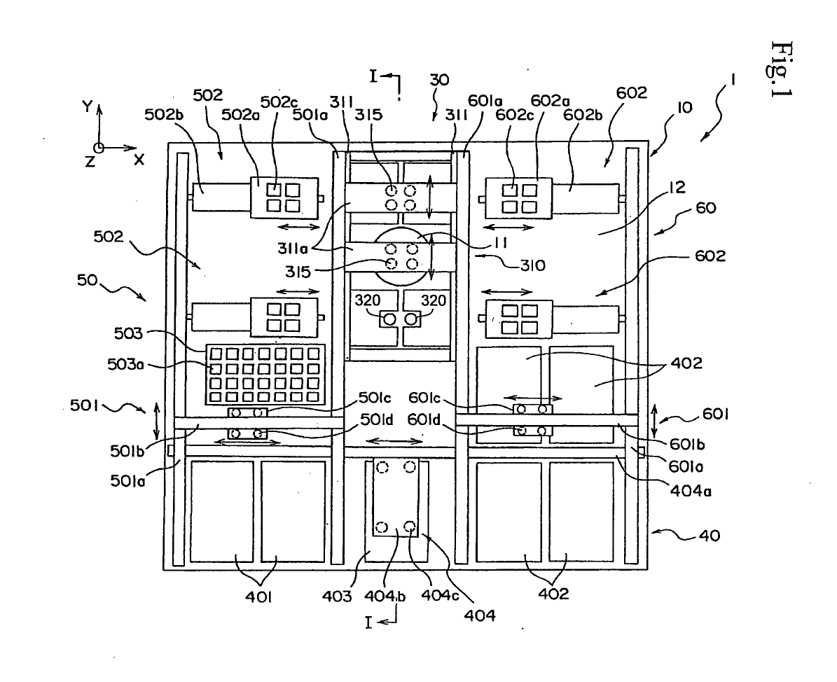

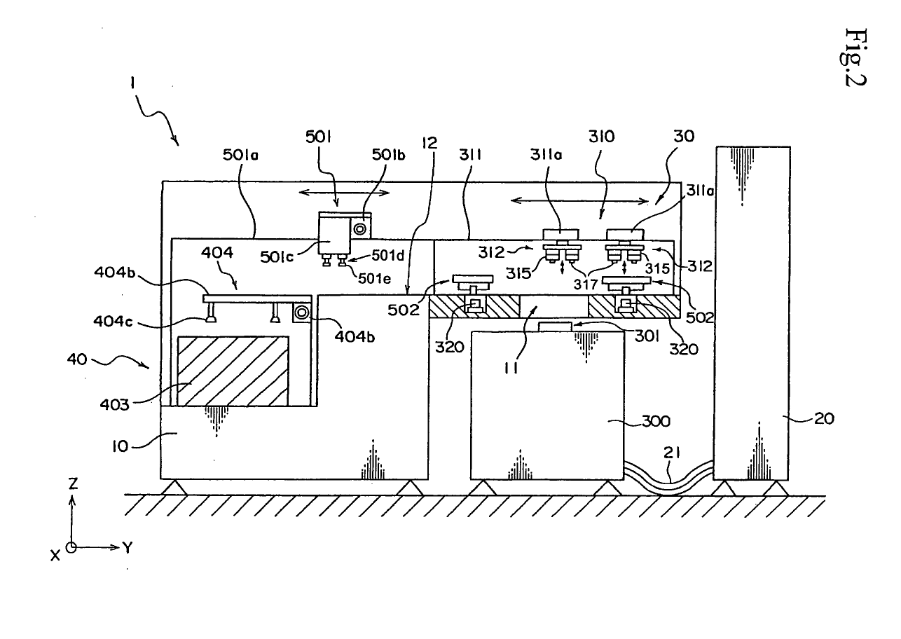

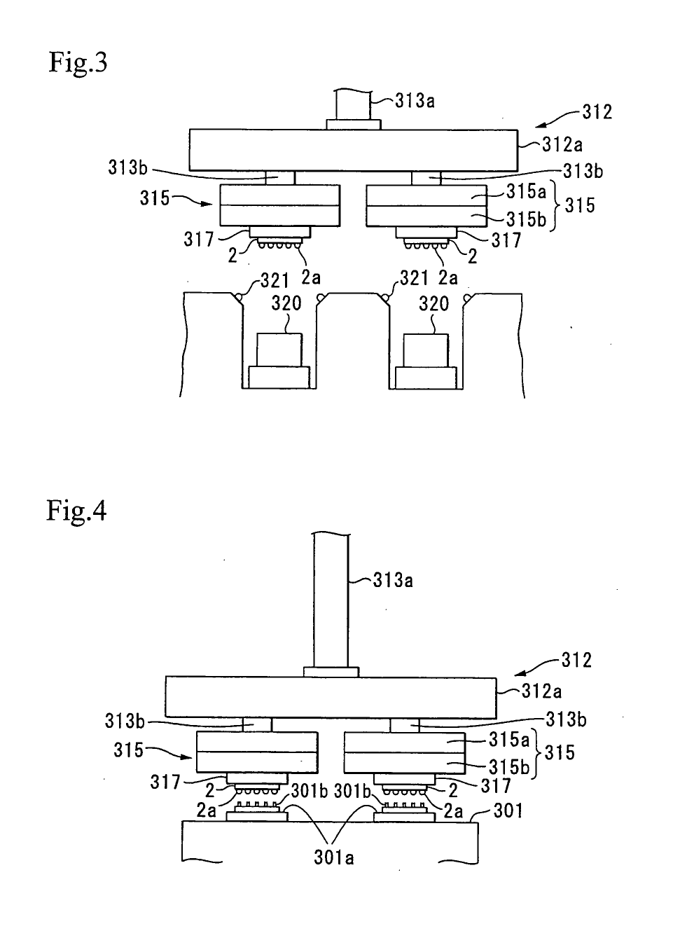

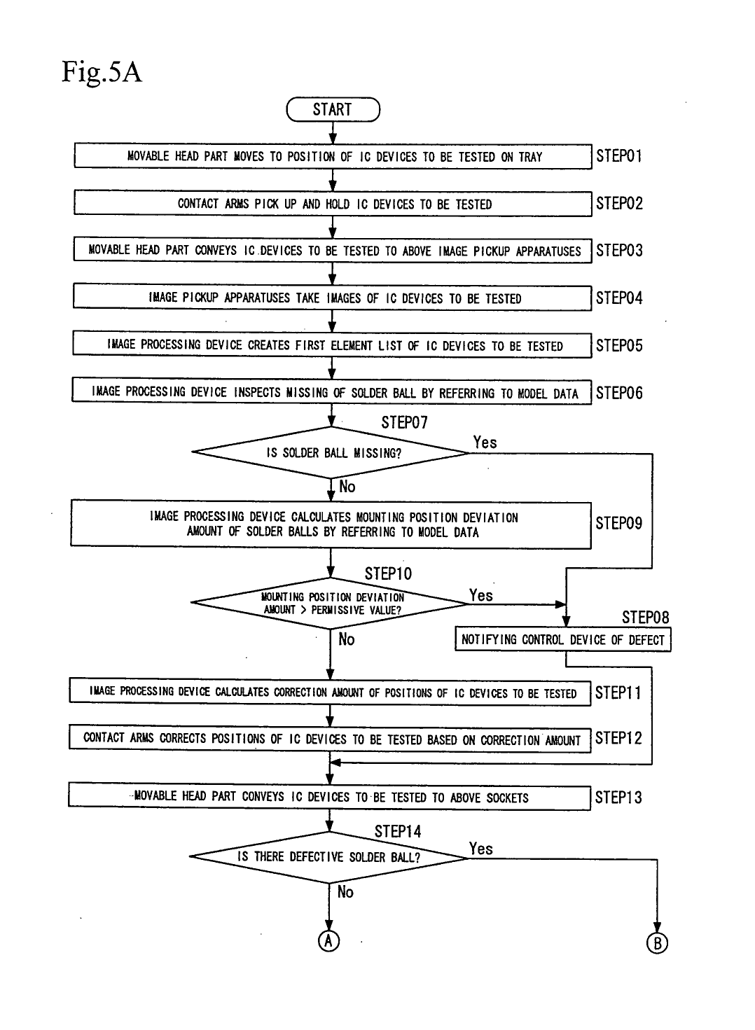

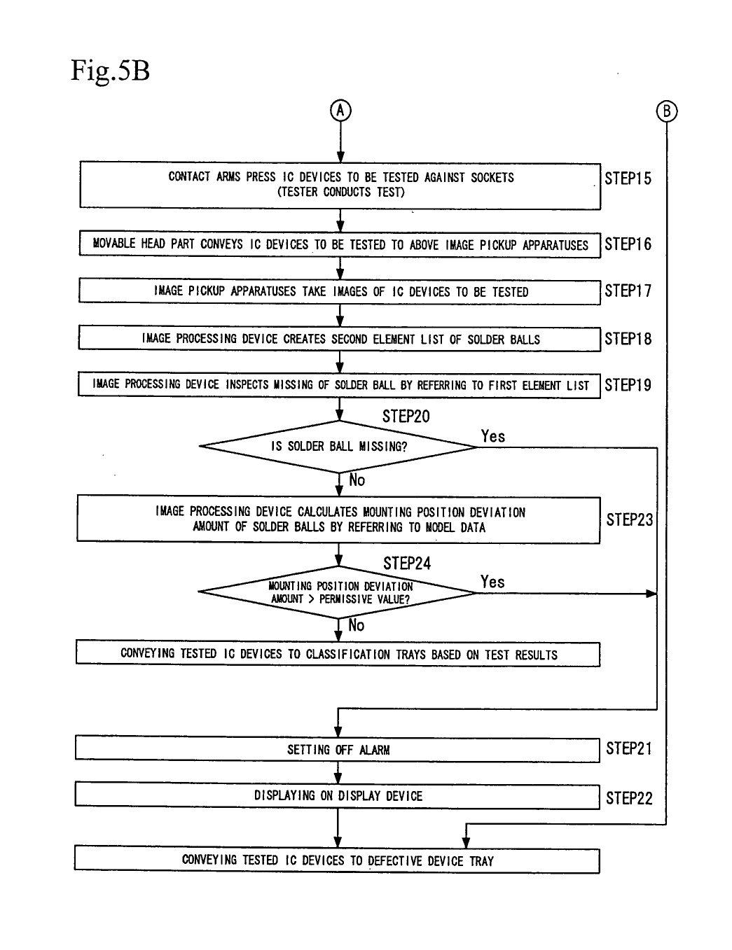

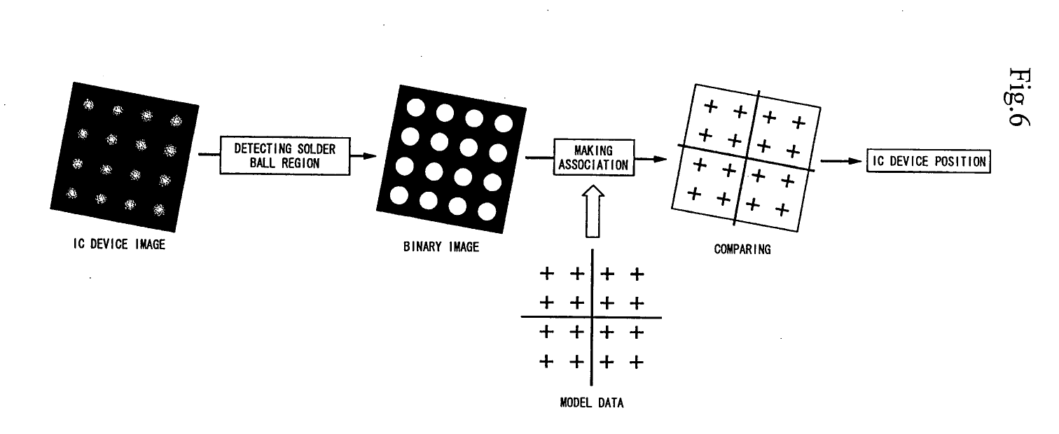

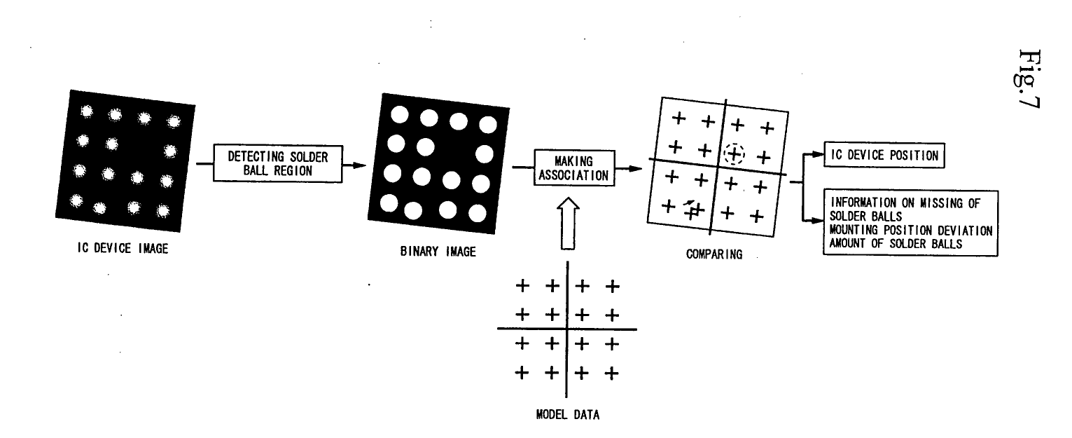

FIG. 1 is a plan view of a handler according to an embodiment of the present invention; FIG. 2 is a sectional view from the side of a part of the handler according to the same embodiment (a sectional view along I-I in FIG. 1); FIG. 3 is a view from the side of a contact arm and an image pickup apparatus used in the handler; FIG. 4 is a view from the side of the contact arm and a contact portion used in the handler; FIG. 5 shows flowcharts showing an operation of the handler; and FIG. 6 and FIG. 7 are conceptual views of an image processing step in the handler.

Note that a form of an IC device to be tested in the present embodiment is, as an example, a BGA or a CSP (chip size package), etc. provided with solder balls as device terminals, but the present invention is not limited to that and it may be a QFP (quad flat package) or SOP (small outline package), etc. provided with lead pins as device terminals.

As shown in FIG. 1 and FIG. 2, an electronic device testing apparatus 1 in the present embodiment comprises a handler 10, a test head 300 and a tester 20, wherein the test head 300 and the tester 20 are connected via a cable 21. Pre-test IC devices on a supply tray stored in a supply tray stocker 401 of the handler 10 are pressed against the contact portion 301 of the test head 300, a test of the IC devices is conducted via the test head 300 and the cable 21, then, the post-test IC devices are loaded on the classification trays stored in the classification tray stocker 402 in accordance with the test results.

The handler 10 mainly comprises a test section 30, an IC device stocker 40, a loader section 50 and an unloader section 60. Below, each component will be explained.

IC Device Magazine 40

The IC device stocker 40 is a means for storing pre-test and post-test IC devices and mainly comprises a supply tray stocker 401, a classification tray stocker 402, an empty tray stocker 403 and a tray conveyor apparatus 404.

In the supply tray stocker 401, a plurality of supply trays loaded with a plurality of pre-test IC devices are placed and, in the present embodiment, two supply tray stockers 401 are provided as shown in FIG. 1.

In the classification tray stocker 402, a plurality of classification trays loaded with a plurality of post-test IC devices are placed and, in the present embodiment, four classification tray stockers 402 are provided as shown in FIG. 1. By providing four classification tray stockers, it is configured that IC devices can be classified to four classes at maximum and stored in accordance with the test results.

The empty tray stocker 403 stores empty trays after supplying all pre-test IC devices loaded on the supply tray stocker 401 to the test section 30. Note that the number of the respective stockers 401 to 403 may be suitably set in accordance with need.

The tray conveyor apparatus 404 is a conveyor means movable in the X-axis and Z-axis directions in FIG. 1 and mainly comprises an X-axis direction rail 404a, a movable head part 404b and four suction pads 404c. An operation range thereof includes the supply tray stockers 401, a part of the classification tray stockers 402 and the empty tray stockers 403.

In the tray conveyor apparatus 404, the X-axis direction rail 404a fixed to a base 12 of the handler 10 supports the movable head part 404b to be movable in the X-axis direction. The movable head part 404b is provided with a not shown Z-axis direction actuator and, at its tip portion, four suction pads 404c.

The tray conveyor 404 picks up and holds by the suction pads 404c an empty tray emptied at the supply tray stocker 401 and transfers them to the empty tray stocker 401 by elevating them by the Z-axis actuator and sliding the movable head part 404b on the X-axis direction rail 404a. In the same way, when a classification tray becomes full with loaded post-test IC devices in the classification tray stocker 402, an empty tray is picked up from the empty tray stocker 403, held, and elevated by the Z-axis direction actuator and by sliding the movable head part 404b on the X-axis direction rail 404a transferred, conveyed to the classification tray stocker 402.

Note that an operation range of the tray conveyor apparatus 404 is provided so as not to superimpose with operation ranges of the later explained loader section conveyor apparatus 501 and unloader section conveyor apparatus 601 in the Z-axis direction as shown in FIG. 2, so that operations of the tray conveyor apparatus 404, the loader section conveyor apparatus 501 and the unloader section conveyor apparatus 601 do not interfere with one another.

Loader Section 50

The loader section 50 is a means for supplying pre-test IC devices from the supply tray stocker 401 of the IC device stocker 40 to the test section 30 and mainly comprises a loader section conveyor 501 and two loader buffer parts 502 (two in the X-axis negative direction in FIG. 1) and a heat plate 503.

Pre-test IC devices are moved from the supply tray stocker 401 to the heat plate 503 by the loader section conveyor apparatus 501 and, after heated to be a prescribed temperature by the heat plate 503, moved again to the loader buffer part 502 by the loader section conveyor apparatus 501 and introduced to the test section 30 by the loader buffer part 502.

The loader section conveyor apparatus 501 is a means for moving IC devices on a supply tray of the supply tray stocker 401 of the IC device stocker 40 to on the heat plate 503 and moving IC devices on the heat plate 503 to on the loader buffer part 502 and composed mainly of a Y-axis direction rail 501a, an X-axis direction rail 501b, a movable head part 501c and a suction portion 501d. The loader section conveyor apparatus 501 operates in a range including the supply tray stocker 401, heat plate 503 and two loader buffer parts 502.

As shown in FIG. 1, the two Y-axis direction rails 501a of the loader section conveyor apparatus 501 are fixed to the base 12 of the handler 10, and between them is the X-axis direction rail 502b supported to be able to slide in the Y-axis direction. The X-axis direction rail 502b supports the movable head part 501c having a Z-axis direction actuator (not shown) to be able to slide in the X-axis direction.

The movable head part 501c is provided with four suction portions 501d each having a suction pad 501e at its lower end portion and able to move the four suction portions 501d upward and downward in the Z-axis direction separately by driving the Z-axis direction actuator.

Each of the suction portion 501d is connected to a negative-pressure source (not shown), capable of picking up and holding an IC device by generating a negative pressure by drawing air from the suction pad 501e and releasing the IC device by stopping drawing air from the suction pad 501e.

The heat plate 503 is a heat source for applying a prescribed thermal stress to IC devices and, for example, a metal heat transfer plate having a heat source (not shown) at its lower part. On an upper surface of the heat plate 503, a plurality of recessed portions 503a for being dropped IC devices are formed. Note that a cooling source may be provided instead of the heat source.

The loader buffer part 502 is a means for moving IC devices back and forth between an operation range of the loader section conveyor apparatus 501 and an operation range of the test section conveyor apparatus 310 and mainly comprises a buffer stage 502a and an X-axis direction actuator 502b.

The buffer stage 502a is supported at one end portion of the X-axis direction actuator 502b fixed to the base 12 of the handler 10 and, as shown in FIG. 3 and FIG. 4, four recessed portions 502c having a rectangular shape when seeing two dimensionally for being dropped IC devices on the upper surface of the buffer stage 502a. The recessed portion 502c is provided with a suction means (not shown) for picking up an IC device placed in the recessed portion 502c.

By providing a loader buffer part 502 as above, it becomes possible that the loader section conveyor apparatus 501 and the test section conveyor apparatus 310 operate at a time without interfering with each other. Also, by providing two loader buffer parts 502 as in the present embodiment, it becomes possible to supply IC devices efficiently to the test head 300 to improve the operation rate of the test head 300. Note that the number of the loader buffer part is not limited to two and may be suitably set based on time required by the test on IC devices, etc.

Test Section 30

The test section 30 is a means for detecting a defect of an external terminal (solder ball) 2a of an IC device 2 to be tested and conducting a test by bringing the solder balls 2a of the IC devices 2 to be tested electrically contact with the contact pins 301b of the sockets 301a of the contact portion 301 after correcting positions of the IC devices 2 to be tested.

Four pre-test IC devices loaded on the loader buffer part 502 are conveyed to above the image pickup apparatuses 320 by the test section conveyor apparatus 310, where positions thereof are corrected, then, moved to the contact portion 301 of the test head 300, subjected to a test by the number of four at a time, then, moved to the unloader buffer part 602 by the test section conveyor apparatus 310 again and taken out by the unloader buffer part 602 to the unloader section 60.

Two image pickup apparatuses 320 are provided on each of both sides of the contact portion 301 of the test head 300 in the Y-axis direction as shown in FIG. 1. As the image pickup apparatus 320, for example, a CCD camera may be used, but it is not limited to that and may be any as far as it is a device capable of taking a picture of an object by arranging a large number of image pickup elements, such as a MOS (metal oxide semiconductor) sensor array.

As shown in FIG. 3, each of the image pickup apparatuses 320 is installed in a recessed portion formed on the base 12 of the handler 10, and a lighting device 321 capable of lighting an IC device 2 positioned above the image pickup apparatus 320 well is provided at an upper end portion of the recessed portion. Note that the respective image pickup devices 320 are connected to a not shown image processing apparatus.

As shown in FIG. 4, the contact portion 301 of the test head 300 is provided with four sockets 301a in the present embodiment, and the four sockets 301a are arranged to be substantially matched with an arrangement of contact arms 315 of the movable head part 312 of the test section conveyor apparatus 310. Furthermore, each socket 301a is provided with a plurality of contact pins 301b in an arrangement of being substantially matching with an arrangement of solder balls 2a of an IC device 2.

As shown in FIG. 2, in the test section 30, an opening portion 11 is formed on the base 12 of the handler 10 and the contact portion 301 of the test head 300 comes out through the opening portion 11 so as to be pressed by an IC device.

The test section conveyor apparatus 310 is a means for moving IC devices between the loader buffer parts 502, the unloader buffer part 602 and the test head 300.

In the test section conveyor apparatus 310, two X-axis direction supporting members 311a to be able to slide in the Y-axis direction is supported by two Y-axis direction rails 311 fixed to the base 12 of the handler 10. The movable head part 312 is supported at the center part of each of the X-axis direction supporting member 311a, and an operation range of the movable head part 312 includes the loader buffer parts 502, the unloader buffer part 602 and the test head 300. Note that the movable head parts 312 supported respectively by the two X-axis direction supporting members 311a operating at a time on a set of Y-axis direction rails 311 are controlled so as not to interfere with each other.

As shown in FIG. 3 and FIG. 4, each of the movable head parts 312 comprises a first Z-axis direction actuator 313a, whose upper end is fixed to the X-axis direction supporting member 311a, a supporting base body 312a fixed to a lower end of the first Z-axis direction actuator 313a, four of second Z-axis direction actuators 313b, whose upper end is fixed to the supporting base body 312a, and four contact arms 315 fixed to a lower end of the second Z-axis direction actuator 313b. The four contact arms 315 are provided to be corresponding to an arrangement of the socket 301a, and the lower end portions of the contact arms 315 are provided with suction portions 317.

Each of the suction portions 317 is connected to a negative-pressure source (not shown) and capable of picking up and holding an IC device by generating a negative pressure by drawing air from the suction portion 317 and releasing the IC device by stopping drawing air from the suction portion 317.

According to the movable head part 312 explained above, four IC devices 2 held by the contact arm 315 can be moved in the Y-axis direction and Z-axis direction and pressed against the contact portion 301 of the test head 300.

The contact arm 315 in the present embodiment has a position correcting mechanism capable of correcting positions of IC devices picked up and held by the suction portions 317, which is composed of a base portion 315a positioned on the upper side and a movable portion 315b positioned on the lower and movable in the X-axis direction, Y-axis direction and the rotation direction (θ direction) when seeing two dimensionally with respect to the base portion 315a.

After correcting positions of IC devices 2 held by the contact arm 315 based on a position correction amount of the IC devices calculated by the image processing device based on image data obtained by the image pickup apparatus 320, the contact arm 315 is capable of pressing the IC devices against the sockets 301a and bringing the solder balls 2a of the IC devices 2 surely contact with the contact pins 301b of the sockets 301a.

Unloader Section 60

The unloader section 60 is a means for taking out post-test IC devices from the test section 30 to the IC device stocker 40 and mainly comprises an unloader section conveyor apparatus 601 and two unloader buffer parts 602 (two in the X-axis positive direction in FIG. 1).

Post-test IC devices loaded on the unloader buffer parts 602 are taken out from the test section 30 to the unloader section 60 and loaded on the classification trays of the classification tray stocker 402 from the unloader buffer parts 602 by the unloader section conveyor apparatus 601.

The unloader buffer part 602 is a means for moving IC devices back and forth between an operation range of the test section conveyor apparatus 310 and an operation range of the unloader section conveyor apparatus 601 and mainly comprises a buffer stage 602a and an X-axis direction actuator 602b.

The buffer stage 602a is supported at one end portion of the X-axis direction actuator 602b fixed on the base 12 of the handler 10, and four recessed portions 602c for being dropped IC devices are formed on an upper surface of the buffer stage 602a.

By providing the unloader buffer part 602 as explained above, it becomes possible that the unloader section conveyor apparatus 601 and the test section conveyor apparatus 310 operate at a time without interfering with each other. Also, by providing two unloader buffers 602, IC devices can be taken out efficiently from the test head 300 and the operation ate of the test head 300 can be improved. Note that the number of the unloader buffer part 602 is not limited to two and may be suitably set based on time required by the test on the IC devices, etc.

The unloader section conveyor apparatus 601 is a means for moving and loading IC devices on the unloader buffer part 602 to the classification tray of the classification tray stocker 402 and mainly comprises a Y-axis direction rail 601a, an X-axis direction rail 601b, a movable head part 601c and a suction portion 601d. An operation range of the unloader section conveyor apparatus 601 includes two unloader buffers 602 and classification tray stocker 402.

As shown in FIG. 1, two Y-axis direction rails 601a of the unloader section conveyor apparatus 601 are fixed to the base 12 of the handler 10, and the X-axis rail 602b is supported to be able to slide in the Y-axis direction between them. The X-axis direction rail 602b supports a movable head part 601c provided with a Z-axis direction actuator (not shown) to be able to slide in the X-axis direction.

The movable head part 601c is provided with four suction portions 601d, each having a suction pad at its lower end portion and able to move the four suction portions 601d upward and downward in the Z-axis direction separately by driving the Z-axis direction actuator.

The handler 10 according to the present embodiment is provided with a storage device for storing model data of a variety of IC devices, a display device capable of displaying images of IC devices, a speaker, a buzzer, an alarm light and other alarm device (all not illustrated). Note that the model data of IC devices includes an arrangement of coordinate data of respective solder balls of an IC device as a standard. In the present embodiment, the coordinate data of solder balls is data of barycentric position coordinate of the solder balls, but it may be data of center position coordinate or specific position coordinate.

Next, an operation of the handler 10 explained above will be explained.

First, the loader section conveyor apparatus 501 uses the suction pads 501e of the four suction portions 501d to pick up and hold four IC devices on the supply tray positioning at the uppermost level of the supply tray stocker 401 of the IC device stocker 40.

The loader section conveyor apparatus 501 elevates four IC devices by the Z-axis direction actuator of the movable head 501c while holding the four IC devices and moves them by sliding the X-axis direction rail 501b on the Y-axis direction rail 501a and sliding the movable head part 501c on the X-axis direction rail 501b.

Then, the loader section conveyor apparatus 501 performs alignment above the recessed portions 503a on the heat plate 503, extends the Z-axis direction actuator of the movable head part 501c, and releases the suction pads 501e to drop IC devices into the recessed portions 503a on the heat plate 503. When the IC devices are heated to a prescribed temperature by the heat plate 503, the loader section conveyor apparatus 501 again holds the heated IC devices and moves to above one of the loader buffer parts 502.

The loader section conveyor 501 performs alignment above the buffer stage 502a of the other standby loader buffer parts 502, extends the Z-axis direction actuator of the movable head part 501c, and releases IC devices picked up and held by the suction pads 501e of the suction portion 501d to put them into the recessed portions 503c on the buffer stage 502a. The suction means provided to the recessed portions 502c picks up and holds the IC devices 2 placed in the recessed portions 502c.

The loader buffer part 502 extends the X-axis direction actuator 502b while holding by suction four IC devices 2 in the recessed portions 502c on the buffer stage 502a and moves the four IC devices 2 from an operation range of the loader section conveyor apparatus 501 of the loader section 50 to an operation range of the test section conveyor apparatus 310 of the test section 30.

An operation in the test section 30 will be explained below with reference to the flowchart in FIG. 5.

When the buffer stage 502a loaded with IC devices 2 moves into the operation range of the test section conveyor apparatus 310 as explained above, the movable head part 312 of the test section conveyor apparatus 310 moves to above the IC devices 2 placed in the recessed portions 502c on the buffer stage 502a (STEP 01). Then, the first Z-axis direction actuator 313a of the movable head part 312 extends, and the suction portions 317 of the four contact arms 315 of the movable head part 312 pick up and hold four IC devices placed in the recess portions 502c on the buffer stage 502a of the loader buffer part 502 (STEP 02). Note that it is preferable that suction at the recessed portions 502c on the buffer stage 502a is released at this time.

The movable head part 312 holding the four IC devices elevates by the first Z-axis direction actuator 313a of the movable head part 312.

Next, the test section conveyor apparatus 310 slides the X-axis direction supporting member 311a supporting the movable head part 312 on the Y-axis direction rail 311 to convey the four IC devices held by the contact arms 315 of the movable head part 312 to above the image pickup apparatus 320 (STEP 03: refer to FIG. 3).

The image pickup apparatus 320 takes an image of a side having solder balls 2a of the IC device 2 (STEP 04). At this time, the lighting device 321 lights the IC devices 2 well. The image processing device creates a first element list of IC devices to be tested including an arrangement of coordinate data of the solder balls 2a able to be compared with the model data (an arrangement of coordinate data of respective solder balls of the IC device as a standard) from image data of the IC devices 2 taken by the image pickup device 320 (STEP 05).

The first element list may be created, for example, as below. First, the taken image data of the IC devices is binarized by using a threshold and a possible range of the solder balls is detected. Then, a barycentric coordinate of the possible range of respective solder balls is calculated and an arrangement thereof (an actually measured arrangement of coordinate data of the solder balls) is prepared. Next, while the model data is moved in the x-direction and y-direction and/or rotated in the θ direction, the number of elements that the coordinate data included in the model data substantially matches with coordinate data of the measured solder balls is counted, and the model data is moved and/or rotated to obtain the maximum number of elements. Then, a moving amount (Δx, Δy) and/or a rotation amount (Δθ) of the model data, by which an error between the coordinate data included in the model data and the measured coordinate data of the solder balls becomes minimum, is obtained. Based on the thus obtained information, the first element list including an arrangement of coordinate data of solder balls (an arrangement of coordinate data of solder balls able to be compared with the model data) corresponding to coordinate data included in the model data is created.

The image processing device compares the first element list created as above with the model data and inspects a missing of solder balls 2a of the IC devices 2 (STEP 06). Specifically, when the first element list does not include coordinate data corresponding to model data, it is determined that the solder balls are missing.

When the solder balls 2a are determined to be missing (STEP 07—Yes), the image processing device notifies the control portion of the handler 10 of information that the IC device 2 is defective (missing of solder ball) (STEP 08), and the procedure jumps to the later explained STEP 13. On the other hand, when it is determined that the solder balls 2a do not have any missing (STEP 07—No), the image processing device compares the first element list with the model data next and calculates an amount of mounting position deviation of solder balls 2a on the IC device 2 (STEP 09).

Here, FIG. 6 and FIG. 7 are views conceptually showing the STEP 04, STEP 05, STEP 06 and STEP 09 explained above, and FIG. 6 is a conceptual view of the case where solder balls of an IC device held by the contact arm does not have any defects, and FIG. 7 is a conceptual view of the case where solder balls of the IC device held by the contact arm 315 have a defective (missing, deviation of mounting positions) portion.

An amount of mounting position deviation calculated as above and a permissive amount (a standard value set in advance: for example, a tolerance of terminal mounting positions in designing an IC device) are compared and, when the amount of mounting position deviation is larger than the permissive amount (STEP 10-Yes), the image processing device notifies the control portion of the handler 10 of information that the IC device 2 is defective (a defect on solder ball mounting position) (STEP 08), and the procedure jumps to the later explained STEP 13. On the other hand, when the amount of mounting position deviation is smaller than the permissive amount (STEP 10—No), the image processing device next calculates a correction amount (δx, δy and δθ) of a position of the IC device 2 (STEP 11). When calculating the position correction amount, positional information of the sockets 301a is also taken into account.

The contact arm 315 of the movable head part 312 moves the movable portion 315b based on the position correction amount (δx, δy and δθ) of the IC devices calculated above (STEP 12).

Next, the test section conveyor apparatus 310 slides the X-axis direction supporting member 311a supporting the movable head part 312 on the Y-axis direction rail 311 and conveys the four IC devices 2 held by the suction portions 317 of the contact arms 315 of the movable head part 312 to above four sockets 301a on the contact portion 301 of the test head 300 (STEP 13).

Then, the control portion of the handler 10 determines whether each of the IC devices 2 held at present has a defective terminal or not and, when determined that there is a defective terminal (STEP 14—Yes), the movable head part 312 does not extend the second Z-axis direction actuator 313b holding the IC device 2 so as not to conduct a test on the IC device 2. The IC device 2 is to be conveyed to a prescribed classification tray (defective device tray) later on.

On the other hand, when it is determined that the IC devices 2 held at present do not have any defective terminals (STEP 13—No), the movable head part 312 extends the first Z-axis direction actuator 313a and the second Z-axis direction actuators 313b holding the IC devices 2 (refer to FIG. 4) and brings the solder balls 2a of respective IC devices 2 contact with the contact pins 301b of the socket 301a (STEP 15). During the contact, electric signals are sent and received via the contact pins to conduct a test on the IC devices 2.

When the test on the IC devices is completed, the test section conveyor apparatus 310 elevates the post-test IC devices 2 by retracting the first Z-axis direction actuator 313a and second Z-axis direction actuator 313b of the movable head part 312 and slides the X-axis direction supporting member 311a supporting the movable head part 312 on the Y-axis direction rail 311 to convey the four IC devices 2 held by the contact arms 315 of the movable head part 312 again to above the image pickup device 320 (STEP 16).

Then, the image pickup device 320 takes an image of a side having solder balls 2a of each of the IC devices 2 again (STEP 17). The image processing device creates a second element list including an arrangement of coordinate data of the solder balls 2a based on image data of the IC devices 2 taken by the image pickup devices 320 (STEP 18). The second element list may be created by the same procedure as that of the first element list explained above.

The image processing device compares the second element list with the first element list to inspect a missing of solder balls 2a of post-test IC devices (STEP 19). Specifically, when the second element list does not include coordinate data corresponding to the first element list, it is determined that a solder ball is missing. Note that, in the present embodiment, the second element list and the first element list are compared, but the second element list may be compared with the model data.

When it is determined that a solder ball 2a is missing (STEP 20-Yes), the control portion of the handler 10 sets off an alarm by the alarm device (STEP 21) and displays a solder ball missing part of the IC devices on the display device (STEP 22). The display device displays, for example, an image of the IC device and a graphic of a cursor, etc. indicating a position of the missing solder ball may be displayed by overlaying on the image of the IC device.

On the other hand, when it is determined that no solder balls 2a are missing (STEP 20—No), the image processing device compares the second element list with the model data next and calculates an amount of mounting position deviation of the solder balls 2a on the post-test IC devices 2 (STEP 23).

When comparing the calculated amount of mounting position deviation with the permissive amount and, when the amount of the positional deviation of the mounting is larger than the permissive amount (STEP 24—Yes), the control portion of the handler 10 sets off an alarm by the alarm device (STEP 21) and displays a solder ball mounting position deviation part of the IC device on the display device (STEP 22). The display device displays, for example, an image of the IC device and a graphic of a cursor, etc. indicating a position of the deviating solder ball may be displayed by overlaying on the image of the IC device.

On the other hand, when the amount of mounting position deviation is smaller than the permissive amount (STEP 24—No), the IC device 2 is to be conveyed to a prescribed classification tray in accordance with the test results later on.

Next, the test section conveyor apparatus 310 slides the X-axis direction supporting member 311a supporting the movable head part 312 on the Y-axis direction rail 311 and conveys the held four IC devices to above the buffer stage 602a of one of the unloader buffer parts 602 standing by in the operation range of the test section conveyor apparatus 310.

The movable head part 312 extends the first Z-axis direction actuator 313a and releases the suction pads 317c to drop the four IC devices to the recessed portions 602c on the buffer stage 602a.

The unloader buffer part 602 drives the X-axis actuator 602b while carrying the post-test four IC devices and moves the IC devices from the operation range of the test section conveyor apparatus 310 of the test section 30 to the operation range of the unloader section conveyor apparatus 601 of the unloader section 60.

Next, the Z-axis direction actuator of the movable head part 601c of the unloader section conveyor apparatus 601 positioning above the unloader buffer part 602 is extended, and the four suction portions 601d of the movable head part 601c pick up and holds post-test four IC devices placed in the recessed portions 602c of the buffer stage 602a of the unloader buffer part 602.

The unloader section conveyor apparatus 601 elevates the four IC devices by the Z-axis direction actuator of the movable head potion 601c while carrying the post-test four IC devices, slides the X-axis direction rail 601b on the Y-axis direction rail 601a and slides the movable head part 601c on the X-axis direction rail 601b to move them to above the classification tray stocker 402 of the IC device stocker 40. Then, the respective IC devices are loaded on a classification tray at the uppermost level of the classification tray stocker 402 in accordance with the test results of the IC devices.

In the handler 10 operating as above, not only position correction of IC devices 2 held by the contact arms 315 with respect to the sockets 301a is possible but also detection of missing of solder balls 2a of IC devices 2 before conducting a test is possible, so that a useless test on an IC device 2 with a missing solder ball 2a does not have to be conducted. Also, since mounting position deviation of the solder balls 2a can be detected before conducting a test, by omitting IC devices 2 having a mounting position deviation amount in an excess of a permissive amount from the test, a possibility that a solder ball 2a falls and remains on the socket 301a can be reduced.

Furthermore, a missing and mounting position deviation of solder balls 2a of post-test IC devices 2 can be also detected, so that it is possible to prevent shipping of an IC device 2, wherein a defect of solder balls 2a arose due to the test even though the test was conducted normally, as it is. Also, when a missing of a solder ball 2a is detected after the test, there is a possibility that the solder ball 2a remains on the sockets 301a, but it is possible to prevent the situation that next IC device 2 to be tested is pressed against the socket 301a, on which a solder ball 2a remains, by setting off an alarm.

The embodiments explained above are described to facilitate understanding of the present invention and is not to limit the present invention. Accordingly, respective elements disclosed in the above embodiments include all design modifications and equivalents belonging to the technical scope of the present invention.

### INDUSTRIAL APPLICABILITY

The electronic device handling apparatus and the detective terminal determination method of the present invention are useful to automatically detect a defect of a terminal of an electronic device without requiring a visual exterior inspection.

1. An electronic device handling device for conveying an electronic device to a contact portion and bringing it contact with the contact portion to test electrical properties of the electronic device, comprising:
a storage device for storing standard positional information of respective terminals of an electronic device as a standard;
an image pickup apparatus for taking an image of terminals of an electronic device to be tested;
a terminal position information obtaining means for obtaining positional information of respective terminals from image data of the terminals of an electronic device to be tested taken by said image pickup apparatus; and
a defective terminal determination means for determining a missing and/or an arrangement position defect of a terminal of an electronic device to be tested by reading standard positional information of respective terminals of the electronic device as a standard from said storage device and comparing the read out standard positional information of respective terminals with positional information of respective terminals of the electronic device to be tested obtained by said terminal position information obtaining means.

2. The electronic device handling apparatus as set forth in claim 1, wherein
said electronic device handling apparatus furthermore comprises a conveyor apparatus capable of holding an electronic device to be tested and pressing it against said contact portion; and
said image pickup apparatus takes an image of terminals of a pre-test electronic device held by said conveyor apparatus.

3. The electronic device handling apparatus as set forth in claim 2, wherein
said electronic device handling apparatus furthermore comprises a position correction amount calculation means for obtaining a correction amount of a position of an electronic device to be tested by comparing standard positional information of respective terminals of the electronic device as a standard read from said storage device with positional information of respective terminals of the electronic device to be tested obtained by said terminal position information obtaining means; and
said conveyor apparatus comprises a position correction device for correcting a position of an electronic device to be tested held by the conveyor apparatus based on the correction amount obtained by said position correction amount calculation means.

4. The electronic device handling apparatus as set forth in claim 1 wherein
an electronic device to be tested determined by said defective terminal determination means that a terminal is missing or an arrangement position of a terminal is defective is omitted from an electric test and/or classified as a defective electronic device.

5. The electronic device handling apparatus as set forth in claim 1 wherein
said conveyor apparatus is capable of holding a plurality of electronic devices to be tested and presses against said contact portion an electronic device to be tested determined by said defective terminal determination means that there is no missing terminal or there is no defect on an arrangement position of a terminal, but does not press against said contact portion an electronic device determined that a terminal thereof is missing or an arrangement position of a terminal is defective.

6. The electronic device handling apparatus as set forth in claim 1, wherein said image pickup apparatus takes an image of terminals of a pre-test electronic device and terminals of a post-test electronic device.

7. The electronic device handling apparatus as set forth in claim 6, furthermore comprising
a second defective terminal determination means for determining a missing and/or an arrangement position defect of a terminal of the post-test electronic device by comparing positional information of respective terminals obtained from image data of terminals of the post-test electronic device taken by said image pickup apparatus with standard positional information of respective terminals of the electronic device as a standard read from said storage device.

8. The electronic device handling apparatus as set forth in claim 6, furthermore comprising
a second defective terminal determination means for determining a missing and/or an arrangement position defect of a terminal of the post-test electronic device by comparing positional information of respective terminals obtained from image data of terminals of the post-test electronic device taken by said image pickup apparatus with positional information of respective terminals of the pre-test electronic device obtained by said terminal position information obtaining means.

9. The electronic device handling apparatus as set forth in claim 1, wherein an electronic device to be tested determined by said second defective terminal determining means that a terminal is missing or an arrangement position of a terminal is defective is classified as a defective electronic device.

10. The electronic device handling apparatus as set forth in claim 1, wherein an alarm sets off when said second detective terminal determining means determines that a terminal is missing or an arrangement position of a terminal is defective.

11. The electronic device handling apparatus as set forth in claim 1, wherein
said electronic device handling apparatus furthermore comprises a display device; and
when said second detective terminal determining means determines that a terminal is missing or an arrangement position of a terminal is defective, said display device displays information on the defective terminal.

12. A defective terminal determination method for determining a missing and/or an arrangement position defect of a terminal of an electronic device to be tested in an electronic device handling apparatus, comprising the steps of:
storing standard positional information of respective terminals of an electronic device as a standard;
obtaining positional information of respective terminals from image data obtained by taking an image of the terminals of an electronic device to be tested; and
determining a missing and/or an arrangement position defect of a terminal of the electronic device to be tested by reading standard positional information of respective terminals of the electronic device as a standard, and comparing the read out standard positional information of respective terminals with said obtained positional information of respective terminals of the electronic device to be tested.

13. The defective terminal determination method as set forth in claim 12, furthermore comprising a STEP of obtaining a correction amount of position of an electronic device to be tested by comparing said standard positional information of respective terminals of the electronic device as a standard with said obtained positional information of respective terminals of the electronic device to be tested and correcting the position of the electronic device to be tested based on the correction amount.

14. The defective terminal determination method as set forth in claim 1, furthermore comprising a step of omitting an electronic device to be tested determined that a terminal is missing or an arrangement position of a terminal is defective and/or classifying it as a defective electronic device.

15. The defective terminal determination method as set forth in claim 1, furthermore comprising steps of
taking an image of terminals of a post-test electronic device; and
determining a missing of a terminal and/or an arrangement position defect of a terminal of the post-test electronic device by comparing positional information of respective terminals obtained from image data of terminals of said post-test electronic device taken an image thereof with said standard positional information of respective terminals of the electronic device as a standard.

16. The defective terminal determination method as set forth in claim 1, furthermore comprising steps of:
taking an image of terminals of a pre-test electronic device;
taking an image of terminals of a post-test electronic device; and
determining a missing of a terminal and/or an arrangement position defect of a terminal of the post-test electronic device by comparing positional information of respective terminals obtained from image data of terminals of said pre-test electronic device taken an image thereof with positional information of respective terminals obtained from image data of terminals of said post-test electronic device taken an image thereof.

17. The defective terminal determination method as set forth in claim 1, furthermore comprising a step of classifying an electronic device to be tested determined that a terminal is missing or an arrangement position of a terminal is defective as a defective electronic device.

18. The defective terminal determination method as set forth in claim 1, furthermore comprising a step of setting off an alarm when determined that a terminal is missing or an arrangement position of a terminal is defective.

19. The defective terminal determination method as set forth in claim 1, furthermore comprising a step of displaying information on a defective terminal on a display device when determined that a terminal is missing or an arrangement position of a terminal is defective.
